(19) United States
(12) Patent Application Publication
(10) Pub. No.: US 2005/0086069 A1
(43) Pub. Date: Apr. 21, 2005

(54) Separable presentation control rules with distinct control effects

(75) Inventors: Stephen Watson, Toronto (CA); Lawrence Kesteloot, San Francisco, CA (US)

Correspondence Address: SWERNOFSKY LAW GROUP PC, P.O. BOX 390013, MOUNTAIN VIEW, CA, 94039-0013, US

(73) Assignee: Kaleidescape, Inc., Mountain View, CA (US)

(21) Appl. No.: 10/964,565

(22) Filed: Oct. 12, 2004

Related U.S. Application Data
(63) Continuation-in-part of application No. 10/655,496, filed on Sep. 3, 2003.
(63) Continuation-in-part of application No. 10/932,330, filed on Aug. 31, 2004.
(63) Continuation-in-part of application No. 10/936,789, filed on Sep. 8, 2004.
(60) Provisional application No. 60/488,367, filed on Jul. 15, 2003.

(51) Int. Cl. G06F 17/60

(52) U.S. Cl. 705/1

(57) ABSTRACT

Parental control rules are logically separated from a set of parental control effects. Control rules are responsive to detectible circumstances, including: business relationships between the DVD owner and its content owner, particular presentation location or device, actual viewers present, date or time. Control effects include ways to edit or suppress inappropriate content, including: defacing via sound or video blanking, skipping scenes, presenting alternative scenes, warning of inappropriate scenes, and similar behavior for associated metadata.

### BACKGROUND OF THE INVENTION

1. Field of the Invention

The invention relates to separable presentation control rules with distinct control effects.

For an example, not intended to be limiting in any way, separation of control rules from control effects allows a controlling user of a home entertainment system to designate control rules with broad applicability to titles having selected properties (such as for example having sexually explicit or excessively violent content), and to designate control rules with broad applicability to types of viewers or locations in which those viewers are likely to be (such as for example young children, or young childrens' bedrooms).

Moreover, separation of control rules from control effects allows an owner of the particular content to designate under what particular circumstances control effects should are applied. For an example, not intended to be limiting in any way, applying a control effect might cause the home entertainment system to refuse to present titles for which the control rules are enforced.

In one embodiment, presentation control rules might be applied to prevent minor children from viewing media streams deemed inappropriate for minors, while allowing non-minors to view those media streams.

In one embodiment, presentation control rules might be responsive to a plurality of factors, such as for example: location of the presentation device (that is, in a child's bedroom versus in a family room), time of the day or time of the week, active or passive detectors for minor children, parental override of the control rules, and the like.

In one embodiment, distinct control effects might be designated in response to differing triggered control rules, such as for example: completely preventing disclosure of the existence of the media stream, allowing review of metadata about the media stream but preventing presentation thereof, editing the media stream with pictures or sounds overlaid over selected portions, editing the media stream by skipping pictures or sounds for selected portions, presenting alternative versions of the media stream, and the like.

As described below, the invention is not at all restricted to, but is applicable to, systems in which media streams might be downloaded or ingested in response to a business relationship with an owner or licensor of those media streams. Moreover, the invention is not at all restricted to, but is applicable to, systems involving media streams, and might also be applicable to other forms of access control.

After reading this application, those skilled in the art would recognize that the “Field of the Invention” includes only a small part of the many possibilities for embodiment or use of the invention, and that the scope and spirit of the invention is not limited in any way to particular examples described in this section or in this application.

2. Related Art

In a home entertainment system (or another system in which data is presented), there might be multiple locations where media streams are presented (or other data is accessed), similar to a home in which there are multiple audio/video players (such as for example, television sets). While users might have relatively large collections of media streams (or other data), either on-hand as physical media, available for download from a remote source, or available for input to the system, it might not be appropriate for some of those media streams (or other data) to be viewed by all the members of the household.

Accordingly, many owners of home entertainment systems desire to have some technique for parental control, in which parents have the capability of locking out children from seeing inappropriate or socially disapproved material.

Some known systems provide for parental control by techniques which involve passwords, physical keys, or other methods or devices for parents to disable the system for presenting selected material to children. For an example, not intended to be limiting in any way, the system could detect the nearby presence of a parent's cell phone (or other radio-responsive device, such as for example an RFID response device, other transponder, or a walkie-talkie).

While these known systems can sometimes achieve the general goals parents have of disabling the system from presenting selected material to children, they have at least the drawback that they must be overridden each time it is desired to present such material.

Some known systems provide for parental control by techniques which involve clocks or timers, with the effect that the system is disabled from presenting selected material during “children's hours.”

While these known systems can sometimes achieve the general goals parents have of disabling the system from presenting selected material to children, they have at least the drawback that they must be overridden each time it is desired to present such material during those hours.

Although involving “override” of the parental control system sounds at first to be a relatively easy matter, it might have a substantial effect on the viewers of the presentation.

For an example, not intended to be limiting in any way, there might be a substantial delay while parents determine (either by remembering or by actually reading the system manual) just how to override parental controls. The inventors believe that there are many families where the children are more adept at overriding parental controls than are the parents.

For an example, not intended to be limiting in any way, there might be a substantial change in the mood of the viewers while parents determine just how to over-ride parental controls. The inventors believe that performance by the system, whether it is displaying materials suitable for children or otherwise, is advantageous when it is as seamless as possible.

Accordingly, it would be advantageous to provide techniques for being able to provide distinct sets of parental control rules in multiple presentation zones, as described above, without the limitations of the known art.

In a home entertainment system (or another system in which data is presented), there might be titles (or other information) about selected media streams (or other data), for which even that little amount of information is inappropriate or socially disapproved for children. For an example, not intended to be limiting in any way, it might be desirable to hide the titles of those media streams which have been prohibited for viewing by children, with one effect of preventing awkward questions by those children to their parents.

Some known distributed media streams have alternative versions, in which those alternative versions are deemed appropriate for alternative presentation contexts. For an example, not intended to be limiting in any way, theater-release movies are sometimes edited for presentation on airlines (to remove scenes which might scare the passengers), or are sometimes edited for presentation on broadcast television (to remove scenes which might be inappropriate for children).

While these known systems can sometimes achieve the general goals of disabling the system from presenting selected material to children, they have at least the drawback that they are inflexible and involve maintaining multiple copies of the media stream (or other data to be presented) for presentation in differing contexts.

Some known distributed media streams have versions in which portions deemed inappropriate have been edited out or replaced with alternative portions. For an example, not intended to be limiting in any way, some such products are available from “Cleanflicks”, a Utah company. See, e.g., information available at http://www.cleanflicks.com/.

This known system is subject to similar drawbacks as other systems described above, as well as that (1) Cleanflicks' technique involves distributing the whole alternative version of the Hollywood movie, and (2) Cleanflicks' technique involves action by the Cleanflicks vendor to select and produce those versions of movies it deems wholesome. For example, to make available a relatively large variety of differently censored versions, this would involve downloading a large numbers of variations of each movie.

Although maintaining multiple copies of media streams sounds at first to be a relatively easy matter, it might have a substantial effect on the system used for presentation.

For an example, not intended to be limiting in any way, maintaining such multiple copies might pose a burden on the system, either in terms of storage (more than one copy of the media stream is maintained in storage), in economics (maintaining multiple copies might involve multiple payments), and in flexibility (the system might find it difficult to determine which of multiple copies to present, especially if there are more than two such copies).

Accordingly, it would be advantageous to provide techniques for being able to provide distinct control effects in response to parental control rules.

These advantages, and others, are achieved using techniques for separable presentation control rules with distinct control effects.

### SUMMARY OF THE INVENTION

The invention provides techniques, embodied in methods and systems, for separable presentation control rules with distinct control effects.

In one aspect of the invention, parental control rules (also herein sometimes called “control rules”) are logically separated from a set of parental control effects (also herein sometimes called “control effects”), with advantageous effect.

Separation of control rules from control effects allows the following separation of functions.
A controlling user of a home entertainment system might designate control rules with broad applicability to titles having selected properties (such as for example having sexually explicit or excessively violent content), and to designate control rules with broad applicability to types of viewers or locations in which those viewers are likely to be locations (such as for example young children, or young childrens' bedrooms).
In contrast, an owner of the particular content might designate control effects that are applied when the control rules indicate that those control effects should be applied. For an example, not intended to be limiting in any way, applying a control effect might cause the home entertainment system to refuse to present titles for which the control rules are enforced.

After reading this application, those skilled in the art would recognize that control effects involve substantially more effort to construct and substantially more information to describe. For example, not intended to be limiting in any way, skipping a scene in a movie generally involves a person reviewing that movie, that person making value judgments (such as, about the beginning and end of that scene, or about which scenes to be skipped), and that person designating bookmarks and watchpoints to indicate the scene to be skipped (if the control rules cause that control effect to be applied), and the like. The inventors believe it would be more effective and efficient for these tasks to be performed once (or at most, a few times) by the owner of the content.

In contrast, after reading this application, those skilled in the art would recognize that control rules typically involve substantially less effort to construct and substantially less information to describe. In one embodiment, control rules are expected to be responsive to viewers and locations (such as for example, if the presentation theater is located in a young child's bedroom), as described below. For example, not intended to be limiting in any way, one control rule might be “presentation theatre ABC (a young child's bedroom) is restricted to play elements with no substantial sex or violence, unless overridden by a viewer with a password and physical key”. The inventors believe that it would be more effective and efficient for control rules to be set by individual (or at most, a few) controllers of each home entertainment system.

For example, not intended to be limiting in any way, the controlling user might interface with the home entertainment system in one or more of the following ways.
The controlling user might set the control rules by answering a set of questions regarding what degrees of sex or violence in the content they would permit for particular individuals and in particular locations.
The controlling user might set the control rules by entering their selection of particular persons to be given access to particular degrees of sex or violence in the content.
The controlling user might set the control rules by entering their selection of particular passwords used to obtain access to particular degrees of sex or violence in the content.

In one aspect of the invention, parental control rules might be responsive to a combination or mixture of detectible circumstances.

For an example, not intended to be limiting in any way, parental control rules might be responsive to one or more of the following.
a selected business relationship, between at least one of a distribution controller, an owner, a publisher, a 3rd or 4th party (for the media stream) and at least one of an owner, a presentation controller, a user, a 3rd or 4th party (for the system)
a selected presentation location or selected presentation device

A preferred embodiment allows a controlling user to designate a set of default control rules for each presentation theater (which can either be a particular location, such as a young child's room, or a particular device, such as a particular portable projector). This has the effect that those default control rules are applied, unless another control rule, also designated by the controlling user, provides an exception. A preferred embodiment includes physical keys and passwords, wielded by mature persons, allowed as exceptions to override the default control rules. In a preferred embodiment, those exceptions may be specific to each presentation theater.
a selected set of actual viewers, whether detected actively or passively

(Active detection might include one or more of the following: a biometric signature, a passcode or password, a physical control device or key. Passive detection might include one or more of the following: a motion or presence detector such as an infrared sensor or a noise sensor or a visible light camera, a location such as outside the presentation region or within the presentation region)
a selected time of the day (such as for example “children's hours”, “prime time”, late night), day of the week (such as for example weekdays, weekends, holidays), or season of the year (such as for example election season, winter season)

In one aspect of the invention, parental control effects might include one or more ways to edit or suppress inappropriate content. For an example, not intended to be limiting in any way, control effects might be set to include one or more of the following.
edit or suppress portions of the content, including possibly scenes edited out for parental control (such as for example defacing via sound or video blanking, sound or video scrambling or pixelation, or skipping those scenes)

In one embodiment, scenes might be skipped using watchpoints and bookmarks, as described in the incorporated disclosure. A beginning point of the scene is detected using a selected watchpoint, at the beginning of the scene. The consequent event of the watchpoint is to transfer presentation to a selected bookmark, at the end of the scene.

In the context of the invention, there is no particular requirement for using the specific forms of bookmarks and watchpoints described in the incorporated disclosure. The scope and spirit of the invention is sufficiently general to include other types of bookmarks and watchpoints, as well as other techniques for skipping or replacing scenes.

Moreover, scenes selected to be skipped might overlap or lie within each other. For an example, not intended to be limiting in any way, one reason this might occur is when a parent desires to remove a short scene to reduce a media stream from an R-rating equivalent to an M-rating equivalent, but also to remove a longer scene to reduce the same media stream from an R-rating equivalent to a G₁₀-rating equivalent. For an example, not intended to be limiting in any way, one reason this might occur is when a parent would desire to remove a portion of a media stream for reasons of sexual content, but would desire to remove a portion of a media stream for reasons of violent content.

This technique is different from that provided by other companies, such as “Clearplay” and “Movie-Mask”, in at least the following ways: (1) The selection of bookmarks and watchpoints is performed by the owner of the content. (2) Bookmarks and watchpoints are more general techniques for describing scenes, and have the ability to include conditional branches and other computational features. See, e.g., the following resources.
www.clearplay.com/About.aspx,
www.afterdawn.com/news/archive/5128.cfm, and
www.usatoday.com/tech/news/techpolicv/2003-02-03-film-censors x.htm.
edit the content, including possibly due to nature of viewers, or due to owner of content

(Editing due to nature of viewers might include several possibilities. For an example, not intended to be limiting in any way, there might be differing versions for intended audience, such as differences in age or disability, differences in education or entertainment purposes, or differences in languages with subtitles. For an example, not intended to be limiting in any way, there might be differing versions for region of publication, such as differences in political slant or news selection, or differences in regulatory restrictions. For an example, not intended to be limiting in any way, there might be differing edited scenes for parental control, such as for example alternative scenes using bookmarks or watchpoints.)

(Editing due to owner of content might include several possibilities. For an example, not intended to be limiting in any way, there might be differing content for “gold” version of the content, such as a “director's cut” or an included videogame. For an example, not intended to be limiting in any way, there might be differing content for “premier” viewers, as defined by the owner of the content, such as in response to large purchases or a user subscription. For an example, not intended to be limiting in any way, there might be restrictions on presentation depending on whether the content is ready (or not ready) for public release.)
warn about aspects of the media stream, such as presenting a message regarding an upcoming scene involving sex or violence, with the effect that a parent can perform a less-automatic form of control effect (for an example, not intended to be limiting in any way, the parent might cover the child's eyes (or their own eyes!), send the child out of the presentation region for a moment, suppress the picture or sound for a moment, pause the presentation for a moment to verbally prepare the child for the upcoming scene), and concepts similar to those described above with reference to editing the content
edit or suppress portions of the metadata, such as suppressing the cover art for the media stream, suppressing the “existence” of the media stream (advantageous at the user side for sexually explicit material, and at the owner side for content that is not ready for release), and concepts similar to those described above with reference to editing the content

After reading this application, those skilled in the art would recognize that the invention provides an enabling technology by which substantial advance is made in the art.

The invention is not limited to media streams (or any other specific type of data) and is not limited to access control for parental purposes (or any other specific type of control).

For example, the invention might be used to provide one or more of, or some combination or extension or mixture of, any of the following.
For an example, not intended to be limiting in any way, the invention might be applied to handling of documents deemed confidential, such as in a company, educational institution, financial institution, research organization, or other organization.
For an example, not intended to be limiting in any way, the invention might be applied to handling telephone calls, such as for example outgoing calls to prohibited phone lines (e.g., phone lines with inappropriate material or “900” or “976” phone lines for which there is a charge to call that phone line), outgoing calls to locations which are prohibited (e.g., long-distance phone calls), or to limit the amount of time allotted to telephone usage (e.g., limited telephone usage as a form of parental control over teenagers).

### BRIEF DESCRIPTION OF THE DRAWINGS

FIG. 1 shows a block diagram of a system capable of providing separable presentation control rules with distinct control effects.

FIG. 2 shows a process flow diagram of a method of operating a system capable of providing separable presentation control rules with distinct control effects.

### INCORPORATED DISCLOSURE

This application incorporates by reference and claims priority of at least the following documents.
U.S. Provisional Patent Application 60/488,367, filed Jul. 15, 2003, attorney docket number 217.1019.01, titled “Bookmarks and Watchpoints for Selection and Presentation of Media Streams”.
U.S. patent application Ser. No. 10/655,496, filed Sep. 3, 2003, attorney docket number 217.1019.02, titled “Bookmarks and Watchpoints for Selection and Presentation of Media Streams”.
U.S. patent application Ser. No. 10/932,330, filed Aug. 31, 2004, attorney docket number 217.1031.01, titled “Displaying and Presenting Multiple Media Streams from Multiple DVD Sets”.
U.S. patent application Ser. No. 10/936,789, filed Sep. 8, 2004, attorney docket number 217.1032.01, titled “Touch Panel User Interface”.
A technical appendix for U.S. Provisional Patent Application 60/488,367, filed Jul. 15, 2003, itself including a document titled “Automatic Masking”.

These documents are hereby incorporated by reference as if fully set forth herein, and are sometimes referred to herein as the “incorporated disclosure”. Inventions described herein can be used in combination or conjunction with technology described in the incorporated disclosure.

### DETAILED DESCRIPTION OF THE PREFERRED EMBODIMENT

In the description herein, a preferred embodiment of the invention is described, including preferred process steps and data structures. Those skilled in the art would realize, after perusal of this application, that embodiments of the invention might be implemented using a variety of other techniques not specifically described, without undue experimentation or further invention, and that such other techniques would be within the scope and spirit of the invention.

Definitions

The general meaning of each of these following terms is intended to be illustrative and in no way limiting.
The phrase “media stream”, and the like, describes information intended for presentation in a sequence, such as motion pictures including a sequence of frames or fields, or such as audio including a sequence of sounds. As used herein, the phrase “media stream” has a broader meaning than the standard meaning for “streaming media,” (of sound and pictures that are transmitted continuously using packets and that start to play before all of the content arrives). Rather, as described herein, there is no particular requirement that “media streams” must be delivered continuously. Also as described herein, media streams can refer to other information for presentation, such as for example animation or sound, as well as to still media, such as for example pictures or illustrations, and also to databases and other collections of information.
The phrase “digital content”, and the like, describes data in a digital format, intended to represent media streams or other information for presentation to an end viewer. “Digital content” is distinguished from packaging information, such as for example message header information. For the two phrases “digital content” and “media stream,” the former describes a selected encoding of the latter, while the latter describes a result of presenting any encoding thereof.
The phrase “content server”, and the like, describes a device (or a portion thereof, or a set of such devices or portions thereof) capable of sending digital content to recipients. For example, a content server might include a web server at which a user is provided the capability of purchasing digital media for download. In the context of this application, there is no particular requirement that the server be (logically or physically) located at any particular address or place, or have any particular architecture, or use any particular protocol for communication. For example, the content server might include a process logically available to a local presentation device.
The term “bookmark”, and the like, describes a reference to a logical location selected within a media stream. In one embodiment, bookmarks are not necessarily pre-selected by the creator or distributor of that media stream, and are possibly dynamically selected by a recipient of digital content representing that media stream. In one embodiment, presentation devices are capable of starting or restarting presentation from a selected bookmark.
The term “watchpoint”, and the like, describe a reference to a logical state of a presentation device, such as for example a logical location selected within a media stream. In one embodiment, watchpoints are capable of associating one or more events therewith, and (preferably) those one or more events might be conditioned on some other data or state information. For one example, the user might designate a bookmark at the beginning of a selected film clip, a watchpoint with the end of that same film clip, and an event associated with the watchpoint, which event directs a presentation device to return to a presentation state it was at before presenting from the bookmark. In this example, the film clip effectively acts as a media element capable of being inserted into another, different, media stream, without involving any other digital content associated with the larger media stream that contains that film clip.
The phrase “digital media,” and the like, describes physical media capable of maintaining digital content in an accessible form. Digital media includes disk drives (including magnetic, optical, or magneto-optical disk drives), as well as any other physical media capable of maintaining information, such as digital content.
The term “DVD,” or digital versatile disc, and the like, is a technology standard that stores data on optical discs. Like the CD (compact disc) that came before it, a DVD holds its information in a digital format as bits denoting ones and zeros on the surface of the disc. A DVD is an example of a form of digital media.
The phrase “DVD package”, and the like, refers to a physical box, probably including at least one DVD. In typical cases, each DVD package has a unique UPC code, includes a single DVD, and on the DVD includes a single movie. However, in the context of the invention, there is no particular requirement for these typical cases. A DVD package might include more than one DVD, more than one movie, more than one version of a single movie, a set of movies, or a set of episodes of a television show. Alternatively, a set of more than one DVD packages might collectively include the same movie (if the movie is too long for a single DVD), or might collectively include more than one movie, or more than one version of the same movie.
The phrase “media object”, and the like, refers to a file maintained at the local server (or at the content server). This has the effect that a media object can represent one or more media streams or play items. In one embodiment, each media object has an associated “media hash” value, computed in response to at least a portion of the digital content representing the media object. In one embodiment, each media hash value is maintained using a “media object database” (at a remote server) and using a “media object local cache” (at a local library).
The phrase “movie guide database” (herein sometimes referred to as the “MGDB”), and the like, refers to the media object database, as described above. An entry in the movie guide database might sometimes herein be referred to as a “movie guide database entry” or an “MGDE”. Responses to requests for information from the movie guide database are herein sometimes referred to as providing the “movie guide database service” or “MGDS”.
The phrase “play item”, and the like, refers to a media stream from the “point of view” of the viewer. This has the effect that a single media object might include more than one play item, or that a single play item might be distributed across more than one media object. In one embodiment, a play item might include a volume, feature, trailer, episode (of a series), individual user selection, credits, and the like. In one embodiment, each play item is associated with a selectable element in a user interface available to the viewer, such as those selectable elements described as part of the “guide” or “mosaic” user interfaces in the incorporated disclosure.
The phrases “control rules”, “parental control rules”, “presentation control rules”, and the like, refer to rules imposed by a controller of the local system (e.g., the home viewing system), that are enforced when users (e.g., viewers) attempt to obtain access (whether access to media streams, their metadata, or other information). For an example, not intended to be limiting in any way, one type of control rule might include a rule that is enforced for a young child's bedroom for all sexually explicit or violent material, unless a parent provides a password over-ride. Typically, control rules have broad applicability to classes of material, such as for example “all sexually explicit material”. For example, a control rule might be of the form: “when playing a movie in the kid's room, allow no more than a G rating, and when playing a movie in the home theater, without a password, allow no more than a PG rating”.
The phrases “control effects”, “parental control effects”, “presentation control effects”, and the like, refer to rules imposed by an owner of content (e.g., a media stream or portion thereof), that are applied when one or more control rules are enforced, such as by refusing to present, editing, or otherwise acting upon otherwise accessible information. For an example, not intended to be limiting in any way, one type of control effect might include an alternative scene to present in 11 place of a scene that includes sexually explicit or violent material, in response to its triggering control rule. Typically, control effects are specific to individual play items, such as individual movies or even individual scenes within movies. For example, a control effect might be of the form: “if a PG rating is desired, then omit the following scenes, and, if a G rating is desired, then do not permit playing of the movie”.
The phrases “control rating”, “parental control rating”, “presentation control rating”, and the like, refer to condensed descriptions of content, with the effect that a controller of the local system can broadly refer to information having such ratings. For an example not intended to be limiting in any way, one type of rating might be “R for graphic violence”, providing the controller of the local system with brief information to determine if play items with that rating are appropriate for children aged 5 or under.

The scope and spirit of the invention is not limited to any of these definitions, or to specific examples mentioned therein, but is intended to include the most general concepts embodied by these and other terms.

System Elements

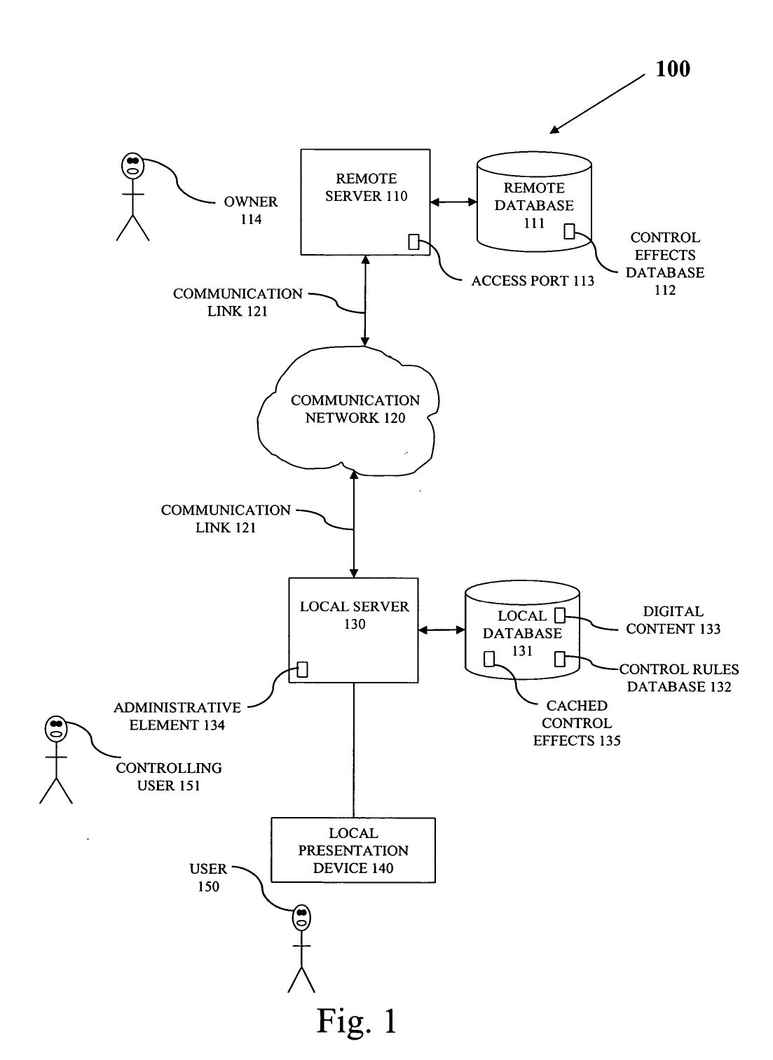

FIG. 1 shows a block diagram of a system capable of providing separable presentation control rules with distinct control effects.

A system 100 includes elements as shown in FIG. 1, plus possibly other elements as described in the incorporated disclosure. These elements include at least a remote server 110, a communication network 120, a local server 130, at least one local presentation device 140, and a user 150.

The remote server 110 includes elements as shown in FIG. 1, plus possibly other elements as described in the incorporated disclosure. These elements include at least a remote database 111, a control effect database 112, and an access port 113 for an owner 114 of digital content. In one embodiment, the remote server 110 includes at least a portion that is either physically, functionally, or logically remote from the local server 130. In one embodiment, the remote server 110 is capable of downloading digital content, as described in the incorporated disclosure, in a cryptographically secure manner, also as described in the incorporated disclosure. Typically, this digital content will be either metadata, a set of bookmarks and watchpoints, or a license to use a media stream, rather than an entire media stream, as the latter is often quite large.

As described in the incorporated disclosure, the digital content has an association with metadata, included in the data maintained in the remote database ill. In one embodiment, the metadata includes information about the digital content (such as for example: its title, actors, cover art, director, publication date, publisher), and set of “official” ratings for the play elements associated with the media streams or digital content. After reading this application, those skilled in the art would recognize that “official” ratings are often not uniform, and may differ in response to country, region, media type, and the like. Moreover, “official” ratings might also include regulatory restrictions, such as prohibitions against presentation of child pornography, “hate speech”, Nazi regalia, and the like. In one embodiment, updates to the remote database ill are periodically downloaded to the local server 130. However, those updates might also be available to the local server 130 upon request to the remote server 110.

In one embodiment, the remote database ill is maintained within the control effect database 112, with the effect that when accessing control effects, it is relatively easy to also access metadata associated with particular media streams. In such cases, control effect database 112 maintains a set of uniform parental control ratings (in contrast with the disparate possible control ratings that might be assigned by different sources or jurisdictions). The control effect database 112 might associate these uniform parental control ratings with particular ratings selected by the controlling user, so that for example, if the controlling user wishes to use U.S. movie theater ratings as their standard, the control effect database 112 would associate its uniform parental control ratings with those U.S. movie theater ratings.

Similar to the remote database ill, the control effect database 112 includes data containing control effects. The control effect database 112 might include substantial information regarding specific play items (such as for example, the placement of bookmarks and watchpoints in those play items, and rating information regarding individual scenes in those play items). As noted above, these control effects might include:
edit or suppress portions of the content—scenes that are edited out might be defaced using sound (such as a loud “bleep”, blanking the sound, or scrambling the sound) or using video blanking (such as a blank or scrambled picture), or pixelation to obscure parts of frames; or portions that might be skipped (such as using watchpoints and bookmarks)
edit portions of the content—edited portions of the content might be in response to (1) age or disability of the viewer (such as a louder soundtrack), (2) educational or entertainment purposes of the play element (such as having or not having a laughtrack or a set of subtitles), (3) intended country or region of viewers (such as what language the play item is presented with, what language the subtitles are presented in, what political slant is imposed on selected scenes, or what selected scenes are replaced with alternative versions due to regulatory restrictions)
edit portions of the content for parental control—as noted above, R-equivalent scenes might be replaced with M-equivalent scenes in response to parental control
edit portions of the content in response to an owner or controller of the content: Edited portions of the content might be in response to (1) alternative versions that might be distributed pre-release as a form of survey of viewers, (2) alternative versions that might be distributed in response to a premier version of the DVD package, such as one including a “director's cut” or additional material such as a video game, (3) alternative versions that might be distributed in response to a premier version of the owner's relationship with the viewer, such as for example a subscription for those viewers desiring additional content, or more dynamically, in response to the amount of business that viewer has done with the owner of the content

After reading this application, those skilled in the art would recognize that control rules are responsive to the nature of the relationship between the owner of or the nature of the content and the controlling user for the home entertainment system, while particular control effects are applied when one or more control rules are enforced.

Control effects, similar to those in which portions of the content are edited, may offer edited portions of the metadata associated with that content—(1) a control effect might be cover art for that play item that is suppressed or edited (so control rules may cause cover art for that play item to appear only in edited form or to be suppressed altogether), (2) a control effect might be to suppress the ability to even find that play item on the system (so control rules may cause that play item to have apparently disappeared altogether from the local system 130).
As noted above, control effects might be associated with an entire play element, a set of selected scenes therein, or some combination thereof. Similarly, as noted above, control effects might be responsive to a combination of the item being controlled (set by the owner 114 of the content) and metadata about the item being controlled.

After reading this application, those skilled in the art will recognize that control ratings are included in the metadata regarding a play item, with the effect that they are set by the owner of the content. However, control ratings can be overridden by the controlling user of the home entertainment system.

Moreover, after reading this application, those skilled in the art will recognize that metadata regarding the play item might cause a distinction in which control effect is applied to the play item, even though the control rule being enforced is responsive to that metadata. For an example, if (1) the controlling user of the home entertainment system were to designate control rules that are enforced when an attempt is made to present a play item including violence in the family room of the house, and (2) the control effect associated with that title is to suppress violent scenes, but (3) over 90% of the play item includes violent scenes, the control effect might be responsive to that third condition, with the effect of refusing to present the play item altogether.

The communication network 120 includes elements as shown in FIG. 1, plus possibly other elements as described in the incorporated disclosure. These elements include at least a communication link 121, which in one embodiment includes internet access. More generally, the communication network 120 might include any possible technique for communication, presently known or unknown.

The local server 130 includes elements as shown in FIG. 1, plus possibly other elements as described in the incorporated disclosure. These elements include at least a local database 131, a control rule database 132, a set of digital content 133 and its metadata, and an administrative element 134. In one embodiment, the local server 130 includes at least a portion that is either physically, functionally, or logically local to the home entertainment system. Typically, there will be one local server 130 for each home entertainment system, but possible to have more than one, whether operating in a master-slave mode, a peer-to-peer mode, or otherwise. The local server 130 is associated with a controlling user 151 for the home entertainment system, with the effect that the controlling user 151 might use the administrative element 134 to add, delete, or edit control rules.

Similar to the remote database ill, the local database 131 includes data maintained with regard to possible control rules to be enforced, as well as any information obtained from the remote server 110 and cached at the local server 130 (typically this would include metadata regarding specific play items and the control effects associated with those play items). In one embodiment, metadata maintained at the local database 131 is periodically and frequently updated with metadata (from the remote database iii) associated with those play elements available to home entertainment system. These metadata might include “official” ratings, which, in one embodiment, are translated by the local server 130 into a set of Kaleidescape ratings.

In one embodiment, the Kaleidescape ratings include at least the following.
G₇—suitable for very young children, such as those age 7 or less
G₁₀—suitable for young children, such as those age 10 or less
M—suitable for “mature” audiences, such as those at least young teenagers
R—suitable for audience such as those at least middle to older teenagers
X—suitable for adults only

In one embodiment, the remote server 130 may translate original parental ratings systems such as MPAA, NR, TV or those of other countries such as Canada, UK, or Australia into a parental ratings system preferred by the user.

In one embodiment, it is possible for distinct play elements associated with the same media stream to have differing ratings. For example, not intended to be limiting in any way, a trailer or advertisement for a feature-length movie might have a “Gio” rating, despite the movie itself having an “R” rating.

Although these ratings are associated with each play item, in one embodiment it is possible for the controlling user 151, such as, for example, using the administrative element 134, to alter or override one or more ratings. This might occur (1) if the controlling user 151 disagrees with that rating, or (2) if the controlling user 151 wishes to make that play element available to viewers with lesser access for some duration of time.

More generally, control effects might themselves be associated with an entire play element, a set of selected scenes therein, and the like. For an example, not intended to be limiting in any way, a control effect might designate (1) that an entire play element (such as for example, an entire movie), is rated “R for graphic violence”, (2) that the entire play element is generally rated “M for violent content,” but that particular scenes are rated “R for graphic content”, “R for sex and violence”, or “R for gratuitous sex and violence in the same scene”. When control effects are specified at such levels of detail, the controlling user 151 might have the option of selecting control rules for the entire content that are distinct from the control rules for the particular selected scenes.

Control effects may also be of the form “if the viewer wishes to see only R content, then this movie is suppressed entirely”. In this way, for example, viewers will not even be aware of children's content at all when choosing adult content.

Control effects may also be for the form “if the viewer is permitted to see only commercial content, then this movie is suppressed entirely”. In this way, for example, guest viewers will not even be aware of home movie content when browsing the system.

As noted above, control rules (as distinct from control effects) might be associated with a set of selected viewers (detected either actively or passively, as noted above), a set of dates and times, and the like. For an example, not intended to be limiting in any way, a control rule might designate (1) that only particular viewers are allowed to present material rated “R”, (2) that no viewers are allowed to present material rated “R” in a young child's bedroom, (3) that only material rated “M” is allowed to be presented in the family room, unless a viewer enters a password to increase the permitted rating to “R”.

As noted above, these control rules might be responsive to:
a selected business relationship, between at least one of a distribution controller, an owner, a publisher, a 3rd or 4th party (for the media stream) and at least one of an owner, a presentation controller, a user, a 3rd or 4th party (for the system)

For an example, not intended to be limiting in any way, the controlling user 151 might set control rules to restrict access to “pay-per-view” play items, or to rented play items for which there is a contractual restriction on the number of presentations allowed, while allowing less limited access to those play items which are “owned” by the controlling user 151.
a selected presentation location or selected presentation device

For an example, not intended to be limiting in any way, the controlling user 151 might set control rules to restrict access to play items in response to their rating and in response to the location of the presentation device within the home entertainment center. This could have the effect that the controlling user 151 could freely allow access to M-equivalent play items, except for in-room viewing by young children.
a selected set of actual viewers, whether detected actively or passively

Similarly, for an example, not intended to be limiting in any way, the controlling user 151 might set control rules to restrict access to play items in response to their rating and in response to the actual viewers present in the presentation region. This could have the effect that the controlling user 151 could freely allow access to M-equivalent play items, and to dynamically pause, halt, or edit those play items if a young child enters the room.

In one embodiment, the system 100 detects the presence of a new viewer entering the room using either passive detection (when the effect is to reduce access to the play item) or active detection (when the effect is to increase access to the play item).

For an example, not intended to be limiting in any way, a motion or presence detector, such as an infrared sensor or a noise sensor or a visible light camera, can be used to detect when a new viewer enters the presentation region. In one embodiment, by default, if the system 100 is unable to determine rights to view the play item (such as due to age or responsibility) associated with the new viewer, the system 100 reduces access to those control rules associated with G₇-equivalent (or perhaps, G₁₀-equivalent) play items.

For an example, not intended to be limiting in any way, a new viewer entering the presentation region can increase access to the play item by presenting identifying material, such as for example a biometric signature, a passcode or password, a physical control device or key. What the system 100 does when that new viewer exits the presentation region is up to the control rules, as they have been set by the controlling user 151.

In one embodiment, the system maintains, but does not present, any technique for invoking those control rules associated with sexually explicit material (or material otherwise embarrassing to the controlling user). In a preferred embodiment, over-ride panels for entering passwords show only entry techniques for material rated less sensitive. It is believed by the inventors that this might spare the controlling user 151 having to explain the existence of those control rules, and what play items that might be covered by them.
a selected time of the day (such as for example “children's hours”, “prime time”, late night), day of the week (such as for example weekdays, weekends, holidays), or season of the year (such as for example election season, winter season)

These restrictions are similar to those regarding a selected set of actual viewers.

In one embodiment, the controlling user 151 might set control rules to restrict presentation brightness or loudness of play items, in response to a time of the day, in response to a day of the week, or in response to whether the particular day is a holiday. This has the effect that the controlling user 151 can restrict the home entertainment system from being played loudly at late hours, with the possible additional effect of making the neighbors happy.

In one embodiment, the controlling user 151 might set control rules to restrict presentation brightness or loudness of play items, in response to detection of new viewers approaching or near the presentation region. This has the effect that the controlling user 151 can restrict the home entertainment system from being played sufficiently loudly that young children can still hear scary movies when they are required to be in bed, with the possible additional effect of reducing nightmares.

The administrative element 134 receives requests from the controlling user 151 of the home entertainment system, and provides responses where appropriate.

As noted above, control rules might be subject to one or more conditions.
one or more sensors, whether active or passive
default control rules, possibly different for distinct locations or times
“hidden” control rules, themselves not available for viewing by other than the controlling user 151
   Method of Operation

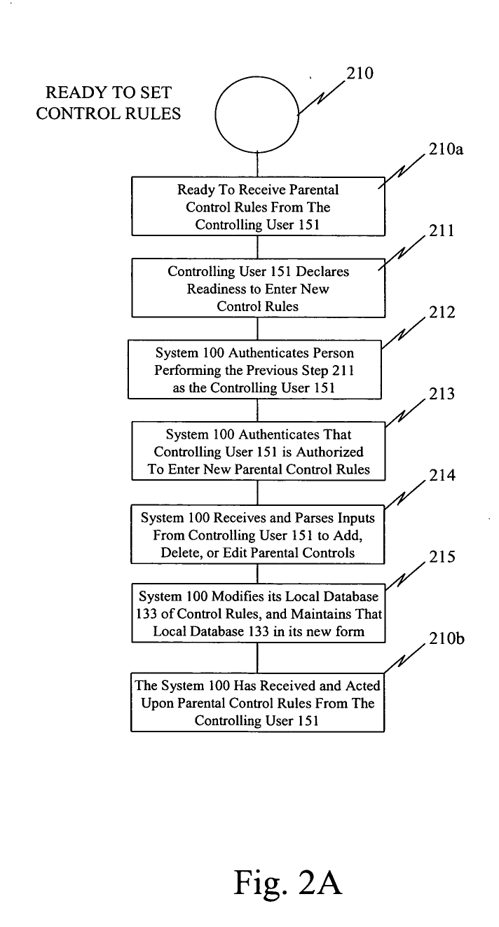

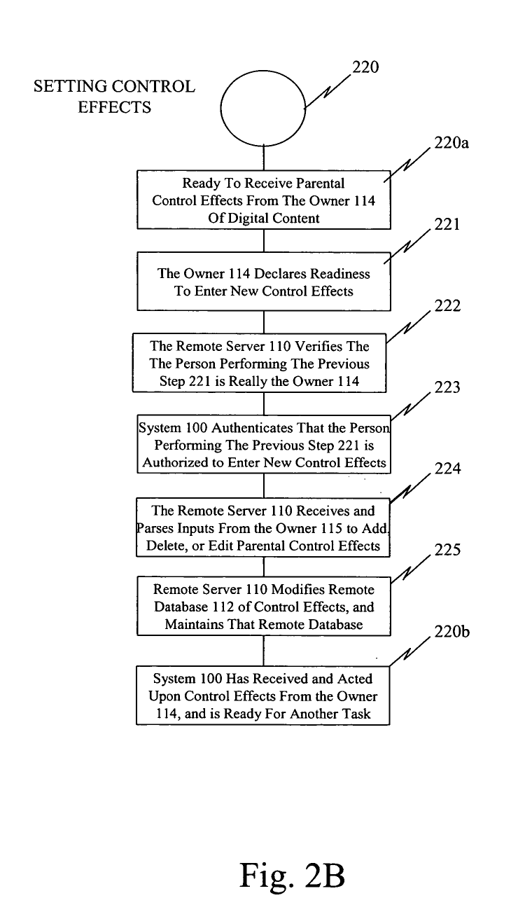

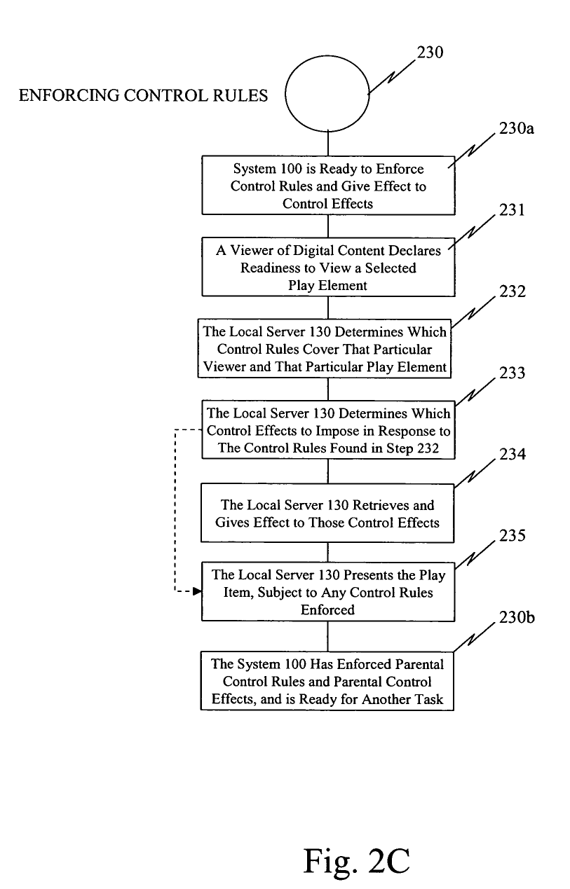

FIG. 2 shows a process flow diagram of a method of operating a system capable of providing separable presentation control rules with distinct control effects.

Although described serially, the flow points and method steps of the method 200 can be performed by separate elements in conjunction or in parallel, whether asynchronously or synchronously, in a pipelined manner, or otherwise. In the context of the invention, there is no particular requirement that the method must be performed in the same order in which this description lists flow points or method steps, except where explicitly so stated.

Setting Control Rules

A flow 210 includes steps for setting control rules at the home entertainment system.

At a step 210a, the system 100 is ready to receive parental control rules from the controlling user 151. In one embodiment, the system 100 starts at the lowest possible control rule level (rules applicable to G₇ viewers), unless the controlling user 151 sets otherwise.

At a step 211, the controlling user 151 declares readiness to enter new control rules.

At a step 212, the system 100 verifies that the person performing the previous step 211 is really the controlling user 151.

At a step 213, the system 100 authenticates that controlling user 151 is authorized to enter new parental control rules. In one embodiment, there might be multiple levels of controllers 151. For an example, not intended to be limiting in any way, parents might exercise complete control over the home entertainment system, teenagers might exercise control with override capability up to M-equivalent only, and childcare providers might exercise control with override capability up to R-equivalent only.

In one embodiment, authentication of a controlling user 151, or creation of a new account for a controlling user 151, might require an exchange of information with the remote server 110.

At a step 214, the system 100 receives and parses inputs from controlling user 151 to add, delete, or edit parental control rules.

At a step 215, the system 100 modifies its local database 133 of control rules, and maintains that local database 133 in its new form.

At a step 210b, the system 100 has received and acted upon parental control rules from the controlling user 151, and is ready for another task.

Setting Control Effects

A flow 220 includes steps for setting control effects for the home entertainment system.

At a step 220a, the system 100 is ready to receive parental control effects from the owner 114 of digital content.

At a step 221, the owner 114 declares readiness to enter new control effects.

At a step 222, the remote server 110 verifies that the person performing the previous step 221 is really the owner 114.

At a step 223, the system 100 authenticates that the owner 114 is authorized to enter new control effects. In one embodiment, there might be multiple levels of owners 114. For an example, not intended to be limiting in any way, these might include media stream producers, media stream publishers (such as for example distributors, licensors, and the like), retail purchase businesses, retail rental businesses, and the like.

At a step 224, the remote server 110 receives and parses inputs from owner 115 to add, delete, or edit parental control effects.

At a step 225, the remote server 110 modifies remote database 112 of control effects, and maintains that remote database 112 in its new form. In one embodiment, frequently and periodically, the remote database 112 (or at least a set of changes thereto) is downloaded to the local server 110.

At a step 220b, the system 100 has received and acted upon control effects from the owner 114, and is ready for another task.

Enforcing Control Rules and Control Effects

A flow 230 includes steps for enforcing control rules and giving effect to control effects.

At a step 230a, the system 100 is ready to enforce control rules and give effect to control effects.

At a step 231, a viewer of digital content declares readiness to view a selected play element.

At a step 232, the local server 130 determines which control rules cover that particular viewer and that particular play element.

At a step 233, the local server 130 determines which control effects to impose in response to the control rules found in the previous step 232. If there are any, the local server 130 proceeds with the next step 234 to enforce those control effects. If there are none, the local server 130 skips the next step 234 and proceeds with the step 235.

At a step 234, the local server 130 retrieves (typically from a local cache), and gives effect to, those control effects.

At a step 235, the local server 130 presents the play item, subject to any control rules enforced, and thus control effects given effect to, in the previous step 234. (It is possible that those control rules and control effects will entirely prevent presentation of the play item.)

At a step 230b, the system 100 has enforced parental control rules and parental control effects, and is ready for another task.

Further Aspects of the Invention

Preferred Control Rules and Control Effects

As described above, control rules and control effects might be used to other advantages.

As described above, in a preferred embodiment, the controlling user designates specific control rules to the effect that “presentation theater ABC has no control effect if the effective rating of the play item is M-equivalent or less, but has control effect XYZ if the effective rating of the play item is R-equivalent or more”. Specific control rules of this form might also include an override provision, such as “unless overridden by a viewer with a key or matching password”. This has the effect that presentation theater ABC (which might be located in a young child's bedroom) has a different set of parental control rules from presentation theaters in other locations.

As described above, in a preferred embodiment, the owner of the content designates metadata regarding the play item. Specific metadata might include information to the effect that “this play item is M-equivalent, except for scenes A, B, C, and D, which are R-equivalent for graphic violence”. The owner of the content also designates control effects regarding the play item. Specific control effects might include “if this play item is played at an M-equivalent rating, then scenes A, B, C, and D are to be omitted”. When a control rule is applied to this play item, the designated presentation theater might only present the play item with scenes A, B, C and D omitted.

Crosstalk

In one embodiment, control rules and control effects might be used to prevent leakage of information from the play element. As noted above, these might include, with regard to appropriateness of the play item and politeness of the owners of the home entertainment system, (1) adjusting brightness or loudness to minimize interference with other presentations, (2) adjusting brightness or loudness during night-time hours or parties, (3) adjusting brightness or loudness to reduce any effect on nearby minors, (4) responding to new viewers entering the presentation region, (5) adjusting the presentation of the play item to minimize side-angle viewing of confidential information in the play item.

Dynamic Enforcement

In one embodiment, control rules and control effects might be enforced dynamically to adjust to changed conditions with regard to presentation of the play element. As noted above, these might include, (1) adjusting the control effects with regard to new viewers entering the presentation region, or with regard to viewers leaving the presentation region, (2) adjusting the control effects with regard to new viewers coming near the presentation region, such as for example adjusting brightness or loudness to minimize their access to the current play item.

Metadata Enforcement

In one embodiment, control rules and control effects might be enforced with regard to metadata for play items, instead of or in addition to, the play items themselves. As noted above, those metadata might include, (1) the “existence” of the play item in the system 100, (2) cover art for the play item, (3) date and time information for the play item, that is, when most recently watched, and by whom.

Statistical Information

In one embodiment, the owner 114 (with regard to control effects) or controlling user 151 (with regard to control rules) might obtain feedback regarding how many or what fraction of play items would be restricted in the event a particular control effect or control rule was implemented. In one embodiment, the system 100 might provide an event count of actual enforcement of control rules or control effects, or of over-rides of those control rules or control effects, to either the owner 114 or controlling user 151. The system 100 might also provide other and further statistical information with regard to its actions as described in this application.

Other Types of Material

As noted above, in the context of the invention, there is no particular limitation to media streams, digital content, or play items. For an example, not intended to be limiting in any way, other types of access control might be applied.
reading material—Control rules might apply to authorization to read (such as for example accounting or financial information, confidential information, human-resources records, medical records, and the like). Control effects might apply to those portions of documents permitted to be read, or to other aspects of reading those documents, such as language of presentation, large type, presentation speed, vocabulary level, and the like.
databases—Similar to reading material, control rules might apply to authorization to access portions of the database. Control effects might apply to those portions of the database permitted to be read or written, or to other aspects of accessing the database, such as what reports are permitted, size of report or time of access, (similar to reading material) language of presentation or presentation speed, and the like.
telephone calls—Control rules might apply to authorization to make telephone calls out or to receive them. For an example, not intended to be limiting in any way, those rules might apply to long-distance calls, to “900” or “976” calls for which there is a charge to call, and to calls with sexual content inappropriate for children, and the like. Control effects might include blocking the call, limiting its duration, and the like.
videogames—Control rules might apply similarly to play items, as described above. Control effects might apply to block play, to various aspects of the game (such as the ability to save game state, levels of the game allowed to be played, sound or graphics quality, and the like).
   Alternative Embodiments

Although preferred embodiments are disclosed herein, many variations are possible which remain within the concept, scope, and spirit of the invention. These variations would become clear to those skilled in the art after perusal of this application.
The invention is not restricted to presentation of movies, but is also applicable to other media streams, such as for example animation, as well as to still media, such as for example pictures or illustrations, and to presentation of databases and other collections of information, or of user interfaces associated with operating systems or application software.
For an example, not intended to be limiting in any way, the invention might be applied to physical access to particular spaces. These spaces might include dangerous rooms (where chemical reagents or heavy equipment are in use), rooms where dangerous implements are available (such as firearms, liquor or tobacco), locations where privacy is desired (teenagers' bedrooms, parents' bedrooms, or locked cabinets having a set of sensitive DVD's), and the like.

After reading this application, those skilled in the art will recognize that these alternative embodiments and variations are illustrative and are intended to be in no way limiting.

After reading this application, those skilled in the art would recognize that the techniques described herein provide an enabling technology, with the effect that heretofore advantageous features can be provided that heretofore were substantially infeasible.

1. A method, including steps of
designating a set of control rules, those control rules being designated at least in part at that substantially local site;
designating a set of control effects, those control effects being designated at least in part at a substantially remote site;
enforcing those control rules, at least in part at the substantially local site;
applying those control effects in response to a result of those steps of enforcing.

2. A method as in claim 1, wherein those control effects are at least in part capable of application at that substantially local site.

3. A method as in claim 1, wherein those control rules are at least in part capable of enforcement at that substantially local site.

4. A method as in claim 1, wherein those control rules are responsive to a selected set of actual viewers.

5. A method as in claim 1, wherein those control rules are responsive to at least one of:
a selected presentation location or selected presentation device;
a selected time of the day, day of the week, or season of the year.

6. A method as in claim 1, wherein those steps of applying are performed at least in part at the substantially local site.

7. A method as in claim 1, wherein those steps of applying are performed with regard to at least one play element.

8. A method as in claim 1, wherein those steps of designating a set of control rules are performed at least in part by a controller of that substantially local site.

9. A method as in claim 1, wherein those control effects include at least one of
suppressing at least a portion of a set of accessible content;
editing at least a portion of that set of accessible content;
warning about at least one upcoming portion of that set of accessible content;
suppressing at least a portion of a set of metadata associated with accessible content.

10. A method as in claim 9, wherein those steps of editing are responsive to an owner of that content.

11. A method as in claim 9, wherein those steps of suppressing accessible content include
skipping at least a first scene in a play item in response to a first control effect; and
skipping at least a second scene in a play item in response to a second control effect;
wherein those first and second scenes overlap at least in part.

12. A method as in claim 9, wherein those steps of suppressing accessible content include skipping at least one scene in a play item.

13. A method as in claim 9, wherein those steps of suppressing accessible content include using at least one of: a bookmark, a watchpoint.

14. A method as in claim 9, wherein those steps of suppressing at least a portion of a set of metadata associated with accessible content include at least one of
suppressing or editing cover art for the content;
suppressing or editing access to knowledge of the existence of the media stream in the system.

15. A method as in claim 9, wherein those steps of warning about at least one upcoming portion of that set of accessible content include at least one of
presenting a message regarding an upcoming scene regarding control by a parent;
waiting an effective time for that parent to exercise some form of control or mitigation of that upcoming portion.

16. A method as in claim 9, wherein that content includes at least one of
documents deemed confidential, including at least one of: in a company, educational institution, financial institution, research organization, or other organization;
handling telephone calls, including at least one of: outgoing calls.

17. A method as in claim 16, wherein those telephone calls include at least one of
phone lines with inappropriate material;
phone lines for which there is a charge to call that phone line;
long-distance phone calls.

18. A method as in claim 17, wherein a set of control effects include at least one of
prohibiting one or more telephone calls;
limiting time allotted to one or more telephone calls;
requiring an account to which to charge one or more telephone calls.

19. A method as in claim 9, wherein those steps of editing at least a portion of that set of accessible content include steps of presenting differing versions of at least one scene in a play element.

20. A method as in claim 19, wherein those differing versions include differences in at least one of: brightness, presentation language, subtitle presentation language, the presence of subtitles, volume.

21. A method as in claim 19, wherein those differing versions include differences in response to at least one of
a purpose of the play element for education, entertainment, instruction, testing;
a region of publication;
a viewer's age, disability, education, known languages.

22. A method as in claim 1, wherein those steps of designating a set of control effects are performed at least in part by an owner of content substantially distinct from a controller of that substantially local site.

23. A method as in claim 22, wherein those control rules are responsive to a business relationship between that owner and that controller.

24. A method as in claim 22, wherein
those steps of applying those control effects are performed with regard to at least one play element; and
that owner has a legal interest in that at least one play element.
